(19) United States
(12) Patent Application Publication
(10) Pub. No.: US 2012/0245729 A1
(43) Pub. Date: Sep. 27, 2012

(54) NETWORK ENABLED DISPENSER

(75) Inventors: JACKSON W. WEGELIN, Stow, OH (US); Patrick J. O'Keefe, JR., Wellington, OH (US); Andrew A. Moore, Wakeman, OH (US)

(73) Assignee: GOJO Industries, Inc.

(21) Appl. No.: 13/070,996

(22) Filed: Mar. 24, 2011

(51) Int. Cl. G06F 17/00

(52) U.S. Cl. 700/231

(57) ABSTRACT

A network enabled dispenser is configured to bidirectionally communicate with a remote computer system via a wireless network. The dispenser transmits operation data to the remote computer system upon the dispensing of material, such as soap. The remote computer system is configured to generate hygiene compliance reports, deliver informational content to the dispenser for presentation thereon, as well as to provide an interface where an administrator can adjust one or more of the dispenser's functions.

### TECHNICAL FIELD

The present invention generally relates to dispensers, such as soap dispensers. Particularly, the present invention relates to a network enabled dispenser that wirelessly bidirectionally communicates with a remote computer system. More particularly, the present invention relates to a network enabled dispenser that is enabled to transmit status information to a remote computer system and that is configured to receive updated operation settings from the remote computer system.

### BACKGROUND OF THE INVENTION

The public has become increasingly concerned with disease and its transmission, and as such, there is a heightened level of awareness of the importance of cleansing and hygiene in general. For example, with respect to the transmission of E. coli in the food services industry, the rhinovirus in elementary schools, and nosocomial diseases within healthcare facilities, numerous studies have cited hand hygiene as an effective measure to guard against disease transmission. In response, the health care industry, the food services industry, and the hotel and travel industries have been forced to examine their protocols and procedures to ensure that their personnel are adopting hand sanitizing habits that are efficacious in the prevention of disease transmission.

In an effort to provide sufficient opportunities for individuals to have access to soap and sanitizers, many institutions and industries have increased the number of installed dispensers to increase the opportunities for individuals to wash or sanitize their hands. However, even with additional dispensers, there is still a lack of compliance with predetermined hand washing hygiene standards. Unfortunately, to minimize the potential transmission of bacteria or viruses by hand washing, full compliance with hand washing hygiene standards must be observed, as the failure of one individual to properly sanitize his or her hands can negate the efforts of others who come in contact with such individuals. Thus, to ensure that full compliance occurs, institutions and industries have installed dispensers with hygiene compliance monitoring functionality and have trained individuals to oversee such systems to ensure that hygiene compliance standards are observed.

In addition, dispensers with hygiene compliance functionality are configured with settings that control various operation parameters of the dispenser, such as shot size. For example, a dispenser that has shot size settings adjusted to dispense liquid soap would dispense an amount of material that is different from that of a dispenser that dispenses moisturizer or sanitizer. As such, such dispensers that dispense one type of material, such as soap, would not be appropriate for use when dispensing other types of liquid material, such as moisturizer. Thus, when it is desired to change the material that is dispensed from the refill container, a new dispenser that is configured to dispense that new material, in the correct quantity and manner, would be required to be installed, or alternatively, the existing dispenser would be required to be mechanically modified to enable the new shot quantity. That is, an individual would be required to interface with each installed dispenser to update it either electronically and/or mechanically to enable the dispenser to dispense a new shot size. Moreover, large institutional settings, where there are a substantial number of dispensers, would require manual reassignment of their location codes that uniquely identify their location in the event that the dispensers are relocated to a different room or area. Furthermore, such installed dispensers may provide an indicator, such as an illuminated indicator, to identify if the dispenser requires service or maintenance, which requires one or more individuals to physically assess each dispenser to evaluate the status of the indicator to determine if the dispensers are in need of repair. Unfortunately, such endeavors are costly and time consuming given the substantial number of dispensers to be managed.

Furthermore, because dispensers are located in areas where there is a substantial amount of traffic by individuals, there are numerous opportunities to communicate information, such as advertising, promotional, educational, or any other informational content thereto. Unfortunately, current dispensers do not provide a convenient and cost-effective system for presenting and/or updating such informational content for viewing by users at multiple dispensers.

Therefore, there is a need for a network enabled dispenser that is able to communicate bidirectionally with a remote computer system to receive updated operation settings wirelessly therefrom. In addition, there is a need for a network enabled dispenser that is able to communicate bidirectionally with a remote computer system so as to transmit collected hygiene compliance data and other operation data thereto for analysis and processing. Furthermore, there is a need for a network enabled dispenser that periodically turns on and off to conserve its operating power. Still yet there is a need for a network enabled dispenser that is configured to receive updated informational content for display thereon.

### SUMMARY OF THE INVENTION

In light of the foregoing, it is a first aspect of the present invention to provide a network enabled dispenser.

It is another aspect of the present invention to provide a dispensing system comprising a dispenser having an actuator and a dispenser transceiver coupled to a dispenser controller, wherein upon the actuation of said actuator, material is dispensed from said dispenser, said dispenser transceiver transmitting operation data based on the operation of said dispenser; and a computer system having a monitoring transceiver to receive said operation data, and said monitoring transceiver configured to transmit update data to said dispenser to adjust at least one function of said dispenser.

Yet another aspect of the present invention is to provide a method of communicating comprising providing a dispenser having a dispenser transceiver, said dispenser having at least one function; providing a computer system having a monitoring transceiver in network communication with said dispenser transceiver; dispensing material from said dispenser; generating operation data based on the operation of said dispenser; transmitting operation data from said dispenser to said monitoring transceiver; and transmitting update data to said dispenser from said computer system to adjust said at least one function.

### BRIEF DESCRIPTION OF THE DRAWINGS

These and other features and advantages of the present invention will become better understood with regard to the following description, appended claims, and accompanying drawings where:

FIG. 1 is a block diagram showing a network enabled dispenser and a remote computer system configured to wirelessly communicate in a bidirectional manner in accordance with the concepts of the present invention;

FIG. 2 is a block diagram showing the bidirectional wireless communication established between the network enabled dispenser and the remote computer system in accordance with the concepts of the present invention; and

FIG. 3 is a flow diagram showing the operational steps taken to enable the bidirectional communication between the network enabled dispenser and the remote computer system in accordance with the concepts of the present invention.

### DETAILED DESCRIPTION OF THE INVENTION

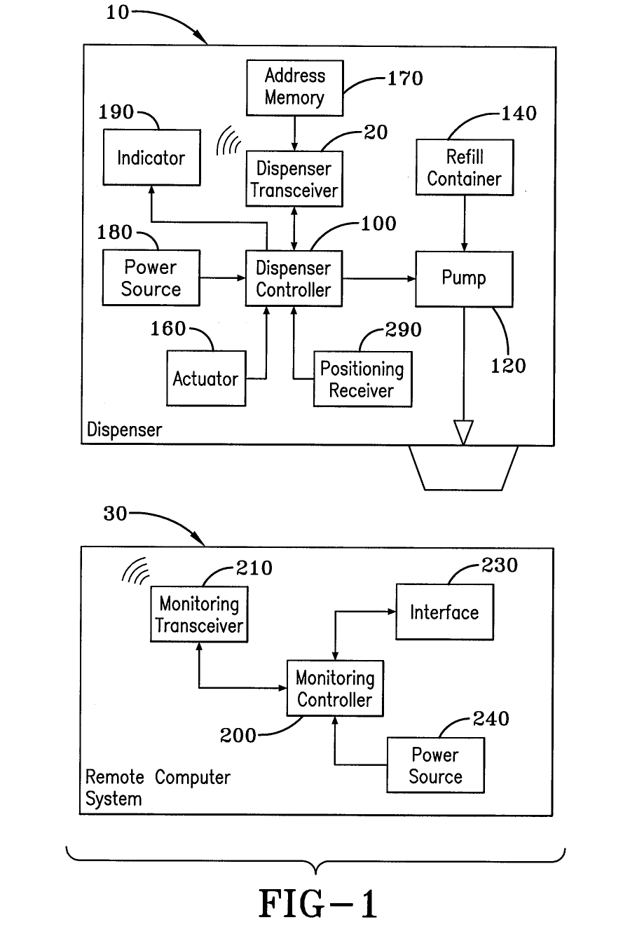

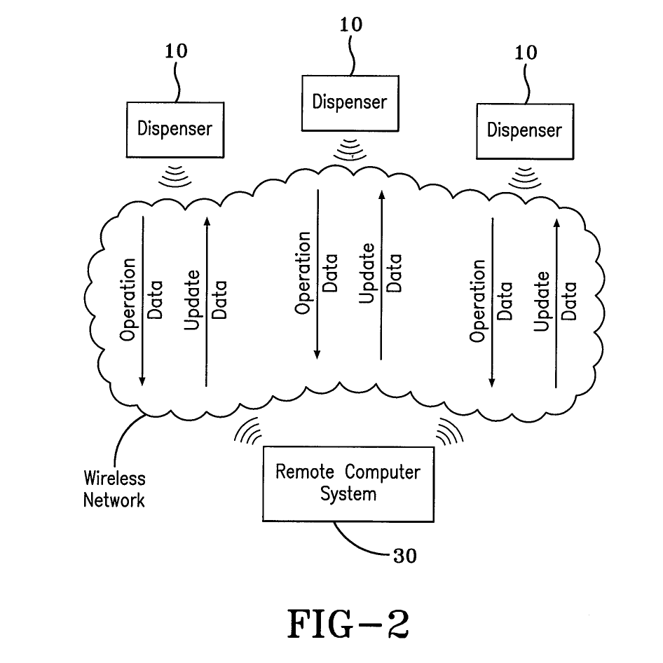

A network enabled dispenser is generally referred to by the numeral 10, as shown in FIG. 1 of the drawings. The dispenser 10 includes a wireless dispenser transceiver 20 that is configured to wirelessly transmit operation data to a remote computer system 30 and that is configured to, receive update data from the remote computer system 30. Specifically, the operation data, which may be collected and transmitted in real-time, comprises any data transmitted by the dispenser 10 that is associated with the operation of the dispenser 10. For example, operation data may include the remaining amount of material to be dispensed and operating power status, while the update data includes data that is used to adjust or modify various operations or functions associated with the dispenser 10, such as shot size. Moreover, update data may include various informational content, such as multimedia data, that is configured for audible and/or visual presentation at the dispenser 10, in a manner to be discussed. As such, the network enabled dispenser 10 and the computer system 30 together form a networked dispensing system in which the dispenser 10 and the computer system 30 communicate in a bidirectional or two-way manner, as shown in FIG. 2. Thus, the present invention allows wireless communication of operation data and update data, thereby facilitating the management and operation of numerous dispensers 10, while also providing hygiene compliance monitoring functionality and the dissemination or presentation of various informational content.

Specifically, the network enabled dispenser 10 includes a dispenser controller 100 that has the necessary hardware and/or software for carrying out the operational features of the dispenser 10, to be discussed. The dispenser controller 100 is coupled to a pump 120 that is configured to dispense any desired liquid material, such as soap, that is contained in a refill container 140 fluidly coupled thereto. Coupled to the dispenser controller 100 is an actuator 160, which may comprise a manual button or any suitable sensor, such as a proximity or biometric sensor, for detecting the presence of the user's hand or proximity of any portion of the user's body. In one aspect, the actuator 160 may be engaged upon the detection of the presence or proximity of the user to the actuator 160 in the case of when the actuator 160 comprises an imaging or proximity detection sensor or upon the manual depression of the actuator 160 in the case of when the actuator 160 comprises a manual button. As such, when the actuator 160 is engaged, the controller 100 actuates the pump 120 to dispense the liquid material from the refill container 140. The dispenser 10 also includes the wireless dispenser transceiver 20 that is coupled to the dispenser controller 100, which is configured to be wirelessly networked with the remote computer system 30 in order to bidirectionally communicate (receive and transmit) data therewith in a manner to be discussed. In one aspect, the dispenser transceiver 20 may be configured to transmit and receive signals using any suitable wireless communication protocol, such as WIFI, BLUETOOTH, WIMAX, ZIGBEE, RUBEE, PEANUT, and IRDA, as well as over-the-air cellular phone data network protocols, such as 3G and 4G protocols, including LTE (long term evolution) cellular networks, for example. It should also be appreciated that the dispenser transceiver 20 may be configured to communicate (receive and transmit) data with the remote computer system 30 using time-synchronized wireless networks, as well as femtocell-based cellular networks. Thus, the dispenser transceiver 20 serves as a network interface and as such, is associated with a unique network address, such as a MAC (media access control) address, that is stored at an address memory 170 coupled to the dispenser transceiver 20 or otherwise incorporated therewith to identify the dispenser 10. As such, the dispenser transceiver 20 and associated network address enables communication of data with various other network enabled devices, such as the remote computer system 30, in a manner to be discussed. The dispenser 10 is powered by a power source 180, such as a battery or solar cell, which is coupled to the controller 100; however, it should be appreciated that the power source 180 may comprise an electrical transformer configured to receive power from a standard electrical wall outlet, as well. Moreover, it should also be appreciated that the power source 180 may comprise a system in which the energy associated with the wireless signals carrying the update data transmitted from the remote computer system 30 is captured or harvested by the dispenser transceiver 20, whereupon it is used to power the dispenser 10 directly and/or is used to charge a battery that is used to power the dispenser 10. In order to identify various status conditions associated with the operation of the dispenser 10, an indicator 190 is coupled to the controller 100. The indicator 190 may comprise any suitable audibly and/or visually perceptible device, such as a speaker or LCD (liquid crystal display) display that is able to indicate various status conditions associated with the operation of the dispenser 10. Such indicated status conditions may include, but are not limited to, indicating when the refill container 140 is empty/low and/or whether the power source 180 is depleted, as well as to indicate the status of any other suitable condition.

In another aspect, it should also be appreciated that the indicator 190 may comprise a dedicated display, such as an LCD (liquid crystal display) display, which is configured to display any desired image, such as moving or static images, including advertisements, promotional messages, or any other informational content provided by the update data to users of the dispenser 10. In addition, the indicator 190 may comprise an audio speaker that is capable of providing advertising or promotional messages, as well as any other promotional content provided in the update data to users of the dispenser 10. Moreover, it should be appreciated that the indicator 190 may comprise both a display and a speaker, so as to provide both audio and video-based informational content to the user of the dispenser 10.

Continuing, the remote computer system 30 that communicates with the dispenser 10 includes a monitoring controller 200 that includes the necessary hardware and/or software necessary for carrying out the functions to be discussed. Coupled to the monitoring controller 200 is a monitoring transceiver 210 that is configured to be wirelessly networked to the dispenser 10 in order to bidirectionally communicate data therewith in a manner to be discussed. In one aspect, the monitoring transceiver 210 may be configured to transmit and receive signals using any suitable wireless communication protocol, including those utilized by the dispenser transceiver 20, as previously discussed. Moreover, the monitoring transceiver 210 and/or the monitoring controller 200 of the computer system 30 are configured to identify the dispenser 10 via its network address that is provided by its address memory 170.

In order to monitor, analyze, and process operation data transferred from the dispenser 10, the remote computer system 30 includes an interface 230 that is coupled to the monitoring controller 200. The interface 230 may comprise a website or web-based interface that is accessible via any suitable wired or wireless computer network, such as the Internet or any other LAN (local area network) or WAN (wide area network). As such, the interface 230 may be accessed using any suitable data communication device, such as a computer that is in network communication with the remote computer system. In addition to receiving operation data from the dispenser 10, the remote computer system 30 is configured such that the website or web-based interface 230 provides a visual representation of the various functions or parameters that can be controlled, set up, or modified at the dispenser 10, while also allowing the user to view collected hygiene compliance status data that has been transmitted wirelessly from the dispenser 10. For example, the various functions or parameters that are associated with the dispenser 10 that can be controlled, set up, or modified, in the case of an audible indicator 190, include the sound and intensity chosen to identify status conditions of the dispenser 10; and in the case of a visual indicator 190, include the particular manner of illumination, such as the rate of flashing, intensity, and the particular images presented by the indicator 190 to identify status conditions of the dispenser 10. Thus, after the desired dispenser operation parameter or function is selected via the interface 230, the remote computer system 30 transmits new operation settings that are associated with the particular operation parameter or function to be modified at the dispenser 10, causing the particular operation parameter or function of the dispenser 10 associated with the operation settings to be modified. As such, the operation of the dispenser 10 can be readily modified remotely or controlled in a desired manner, thus saving time and resources that would otherwise be expended if an individual were required to physically interact with each individual dispenser being modified.

Finally, the remote computer system 30 is powered by a power source 240, which may comprise a portable power source, such as a battery or solar cell, or an electrical transformer configured to receive power from a standard electrical wall outlet.

The dispenser 10 is normally placed in a reduced power mode, whereby the dispenser transceiver 20 is placed in a normally off state, such that communication between the dispenser transceiver 20 and the monitoring transceiver 210 of the remote computer system 30 is suspended, so as to conserve power at the dispenser power source 180. In addition, during the reduced power mode, the dispenser controller 100 may also be placed in a low or reduced power state to conserve additional power. Next, at specific time intervals, or after each dispensing event, or after a predetermined number of dispensing events, or after any combination thereof have been completed, the dispenser 10 transitions periodically from the reduced power mode to a full power mode. Once the dispenser transceiver 20 and/or dispenser controller 100 has been fully activated, the dispenser transceiver 20 communicates with the remote computer system 30 in order to transmit operation data thereto, while the computer system 30 is enabled to transmit revised update data to the dispenser 10 to modify its operation. For example, operation settings that are transmitted to the dispenser 10 may adjust one or more of the following operation parameters including: controlling the indicator 190 in a particular manner to indicate that the quantity of liquid material in the refill container 140 is low or that the dispenser power source 180 is low, to modify the shot size or amount of liquid material dispensed from the refill container 140 of the dispenser 10, to modify the distributor key used to access the refill container 140 housed within the dispenser 10, to enable the dispenser 10 to download new firmware used to control the operation of the dispenser 10, and to change a location identification code, which uniquely identifies the specific location of the dispenser 10.

In one aspect, the remote computer system 30 may be configured to transmit update data to the dispenser 10, so as to visually and/or audibly present various informational content via the indicator 190. That is, the update data may include informational content that is transmitted from the computer system 30 to the dispenser 190 for audible and visual presentation by the indicator 190. For example, the update data may include advertisements; news headlines; radio station broadcasts; schedules, such as health and fitness schedules; alerts to notify individuals in an attempt to divert users to other dispenser locations; promotional information; or any other informational content that can be presented audibly and/or visually via the indicator 190.

Furthermore, the computer system 30 may process received operation data in real-time, which may include the number of completed hygiene events, to generate hygiene compliance data or to determine the particular update data to be sent to the dispenser 10.

In another aspect, the dispenser 10 may include a positioning receiver 290, which may comprise a GPS (global positioning system) receiver and/or a local positioning system receiver that is coupled to the dispenser controller 100. Specifically, the positioning receiver 290 is configured to identify the specific location of the dispenser 10 and communicate it as operation data to the remote computer system 30. As such, the remote computer system 30 is able to develop a map that identifies the location of each particular dispenser 10. In conjunction with the positioning data and the other operation data received from the dispenser 10, the remote computer system 30 is able to identify the following: whether a particular dispenser 10 or group of dispensers 10 are in need of replenished refill containers 140, the remaining quantity of liquid material that is remaining at a particular dispenser, the battery status of a particular dispenser 10, the specific operational problems of a particular dispenser 10, and whether damage or theft has occurred at a particular dispenser 10.

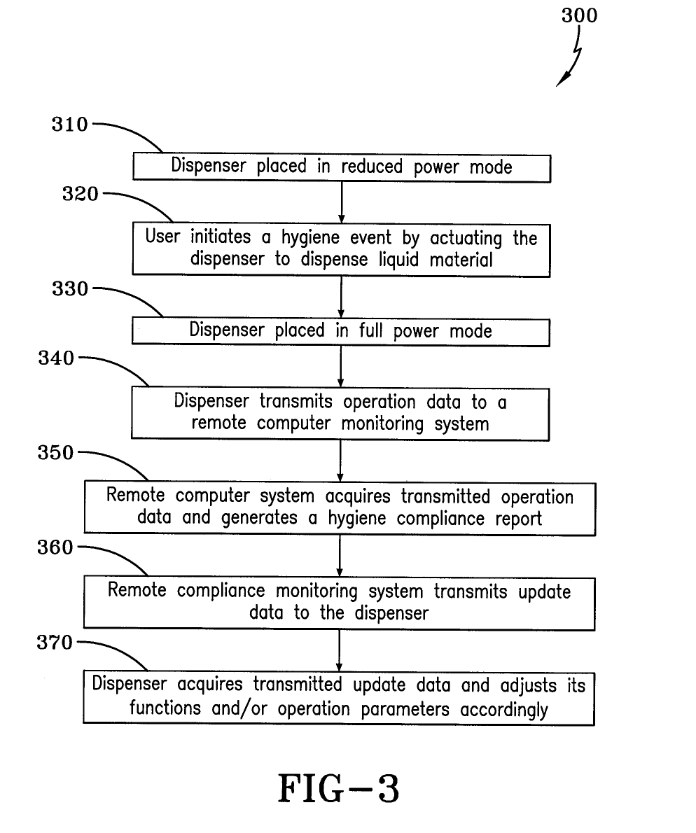

With the structural components of the dispenser 10 and the remote computer system 30 set forth, the following discussion presents the operational steps, generally referred to by numeral 300, as shown in FIG. 3, which are taken by the dispenser 10 and the remote computer system 30 during the bidirectional communication of operation data and update data. Initially, at step 310, the dispenser 10 is placed in the reduced power mode, as previously discussed. Next, at step 320, a user of the dispenser 10 engages the actuator 160, causing the dispenser controller 100 to actuate the pump 120, so as to dispense an amount of liquid material therefrom, thus completing a hygiene event. After the completion of step 320, the dispenser 10 is placed in the full power mode, such that the dispenser transceiver 30 and/or dispenser controller 100 are fully powered, as indicated at step 330. Next, at step 340, the dispenser 10 transmits operation data, such as the completion of a hygiene event, to the remote computer system 30 via an established wireless network connection, indicating that the hygiene event has been completed. As previously discussed, the operation data transmitted by the dispenser 10 may include any information associated with the operation of the dispenser 10, as well as any component of the dispenser 10, including: the date and time of a completed hygiene event, the shot size of the hygiene event, the operational status of one or more of the components of the dispenser 10, the status of the power source used by the dispenser 10, the location of the dispenser 10, the amount of liquid material remaining to be dispensed at the dispenser 10, and the unique identification code associated with the dispenser 10. Continuing to step 350, the monitoring transceiver 260 of the remote computer system 30 acquires the transmitted operation data and processes it in various manners. For example, the operation data may be processed to generate a hygiene compliance report that summarizes a user's compliance with predetermined hygiene standards. In addition, the computer system 30 may process the operation data in the manner previously discussed to identify various operating conditions of each dispenser 10, such as the remaining amount of material in the refill container 140, and the remaining capacity of the power source 180. In addition to receiving operation data from the dispenser 10, the process optionally continues to step 360, where the remote computer system 30 is configured to transmit update data to the dispenser transceiver 20 of the dispenser 10 to change or modify one or more operating functions of the dispenser 10, as previously discussed. In one aspect, the update data may be automatically transmitted based on the hygiene compliance report generated at step 350 or on the operation data directly. Alternatively, the user may utilize the interface 230 to select and modify a desired function or parameter of a dispenser, whereupon it is transmitted to the dispenser 10 as update data. In the event that update data are generated and transmitted by the remote computer system 30, the process continues to step 370, where the transmitted update data are received or acquired by the dispenser 10 and processed by the dispenser controller 100, so as to adjust the various operation functions or parameters provided by the dispenser 10 in accordance with the update data.

It will, therefore, be appreciated that one advantage of the present invention is that functions provided by a network enabled dispenser may be remotely modified from a computer system. Another advantage of the present invention is that a network enabled dispenser uses reduced power when transmitting operation data and receiving update data. Still another advantage of the present invention is that a network enabled dispenser is able to bidirectionally communicate data over a wireless network with a remote computer system. Yet another advantage of the present invention is that a network enabled dispenser is able to receive update data to remotely control one or more of its operating functions. Still another advantage of the present invention is that a network enabled dispenser is configured to present informational content included in update data received from the remote computer system.

Although the present invention has been described in considerable detail with reference to certain embodiments, other embodiments are possible. Therefore, the spirit and scope of the appended claims should not be limited to the description of the embodiments contained herein.

What is claimed is:

1. A dispensing system comprising:
a dispenser having an actuator and a dispenser transceiver coupled to a dispenser controller, wherein upon the actuation of said actuator, material is dispensed from said dispenser, said dispenser transceiver transmitting operation data based on the operation of said dispenser; and
a computer system having a monitoring transceiver to receive said operation data, and said monitoring transceiver configured to transmit update data to said dispenser to adjust at least one function of said dispenser.

2. The dispensing system of claim 1, wherein said computer system includes an interface to modify said update data.

3. The dispensing system of claim 1, wherein said dispenser transceiver and said monitoring transceiver communicate over a wireless network.

4. The dispensing system of claim 1, wherein said computer system generates a hygiene compliance report based on said received operation data.

5. The dispensing system of claim 1, wherein said dispenser transceiver transitions from a reduced power mode to a full power mode upon the actuation of said actuator.

6. The dispensing system of claim 5, wherein said dispenser transceiver returns to said reduced power mode after a predetermined amount of time.

7. The dispensing system of claim 1, further comprising an indicator coupled to said dispenser controller to present said update data.

8. The dispensing system of claim 1, wherein said computer system receives and processes said operation data in real-time.

9. The dispensing system of claim 1, further comprising a positioning receiver coupled to said dispenser controller to associate the location of said dispenser with said operation data.

10. The dispensing system of claim 1, further comprising an address memory coupled to said dispenser transceiver, said address memory storing a unique network address to identify said dispenser.

11. A method of communicating comprising:
providing a dispenser having a dispenser transceiver, said dispenser having at least one function;
providing a computer system having a monitoring transceiver in network communication with said dispenser transceiver;
dispensing material from said dispenser;
generating operation data based on the operation of said dispenser;
transmitting operation data from said dispenser to said monitoring transceiver; and
transmitting update data to said dispenser from said computer system to adjust said at least one function.

12. The method of claim 11, further comprising:
placing said dispenser transceiver in a reduced power mode prior to said dispensing step; and
placing said dispenser transceiver in a full power mode after said dispensing step.

13. The method of claim 11, wherein said dispenser includes an indicator to present said update data.

14. The method of claim 11, wherein said generating step is completed in real-time.

15. The method of claim 11, wherein said dispenser transceiver includes a unique network address that is used by said network computer to identify said dispenser.
